(19) United States
(12) Patent Application Publication
(10) Pub. No.: US 2012/0120930 A1
(43) Pub. Date: May 17, 2012

(54) VEHICLE NETWORK SYSTEM INTERCONNECTING WITH A HOME NETWORK

(75) Inventors: Sang Woo Ji, Hwaseong (KR); Jun Hyeong Lee, Hwaseong (KR); Hyun Cheol Bae, Suwon (KR); Hun Joung Yoon, Hwaseong (KR)

(73) Assignee: HYUNDAI MOTOR COMPANY, Seoul (KR)

(21) Appl. No.: 13/099,534

(22) Filed: May 3, 2011

(30) Foreign Application Priority Data
Nov. 12, 2010 (KR) 10-2010-0113042

(51) Int. Cl. H04W 4/00

(52) U.S. Cl. 370/338

(57) ABSTRACT

The present invention provides a vehicle network system interconnected with a home network that includes a vehicle information collection unit and a wireless transceiver unit. The vehicle information collection unit detects accident information or management information of a vehicle and the wireless transceiver unit transmits information detected by the vehicle information collection unit to the home network via a wireless communication network and is configured to receive a response signal from the home network.

### CROSS-REFERENCES TO RELATED APPLICATIONS

Priority to Korean Patent Application Number 10-2010-0113042, filed on Nov. 12, 2010, which is incorporated herein by reference in its entirety, is claimed.

### BACKGROUND OF THE INVENTION

1. Field of the Invention

The present invention relates to a vehicle network system interconnected with a home network, and more particularly, to a vehicle network system, which controls functions operated in a home network and receives various information from the home network.

2. Description of the Related Art

Generally, a smart home system is connected to a home server in an apartment or a residential area to control communication within a home or control home electronic devices. By using a smart home system, electronic devices inside the home can be controlled while home security can be automatically monitored. Accordingly, there is an increasing need for a device that can transmit and receive data in connection with a communication system provided within a vehicle. Namely, there is a need for a system that can communicate with the smart home system to control a home from inside the vehicle by using the communication system that is interconnected with the home network. In doing so, a smart home system that can manage vehicle information is also needed.

### SUMMARY OF THE INVENTION

The present invention provides a vehicle network system interconnected with a home network within a vehicle. More specifically, the vehicle network system is capable of controlling smart home functions performed by the home network and providing vehicle management information to the home network accordingly.

In accordance with an aspect of the present invention, provided is a vehicle network system interconnected with a home network, the vehicle network system includes a vehicle information collection unit configured to detect accident information or management information of a vehicle; and a wireless transceiver unit configured to transmit information detected by the vehicle information collection unit to the home network via a wireless communication network and receive a response signal from the home network.

In accordance with another aspect of the present invention, a vehicle network system interconnected with a home network, may further include a user input unit, a wireless transmission unit, a wireless reception unit, and a display unit. More specifically, the user input unit, in this embodiment, is configured to receive, from a user, a request for a control function which is operable in the home network and the wireless transmission unit is configured to request the control function requested through the user input unit to the home network via a wireless communication network. The wireless reception unit, on the other hand, receives a result of the control function operated by the home network via the wireless communication network. As noted above this embodiment of the present invention may also include a display unit which displays the result which was transmitted through the wireless reception unit.

In accordance with still another aspect of the present invention, provided is a vehicle network system interconnected with a home network, which, upon the occurrence of an event detectable by the home network, transmits information corresponding to the event. The vehicle network system in this embodiment further includes a wireless reception unit that can receive information transmitted from the home network via a wireless communication network; and a display unit which can be configured to display a result transmitted through the wireless reception unit.

### BRIEF DESCRIPTION OF THE DRAWINGS

The objects, features and advantages of the present invention will be more apparent from the following detailed description in conjunction with the accompanying drawings, in which:

FIG. 1 is a view illustrating a vehicle network system and a home network according to an exemplary embodiment of the present invention;

FIG. 2 is a view illustrating a configuration of a vehicle network system according to an exemplary embodiment of the present invention;

FIG. 3 is a flowchart illustrating a method of operating a vehicle network system according to a first exemplary embodiment of the present invention;

FIG. 4 is a flowchart illustrating a method of operating a vehicle network system according to a second exemplary embodiment of the present invention;

FIG. 5 is a flowchart illustrating a method of operating a vehicle network system according to a third exemplary embodiment of the present invention;

FIG. 6 is a flowchart illustrating a method of operating a vehicle network system according to a fourth exemplary embodiment of the present invention;

FIG. 7 is a flowchart illustrating a method of operating a vehicle network system according to a fifth exemplary embodiment of the present invention;

FIG. 8 is a flowchart illustrating a method of operating a vehicle network system according to a sixth exemplary embodiment of the present invention;

FIG. 9 is a flowchart illustrating a method of operating a vehicle network system according to a seventh exemplary embodiment of the present invention;

FIG. 10 is a flowchart illustrating a method of operating a vehicle network system according to an eighth exemplary embodiment of the present invention;

FIG. 11 is a flowchart illustrating a method of operating a vehicle network system according to a ninth exemplary embodiment of the present invention; and

FIG. 12 is a flowchart illustrating a method of operating a vehicle network system according to a tenth exemplary embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

It is understood that the term “vehicle” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example, both gasoline-powered and electric-powered vehicles.

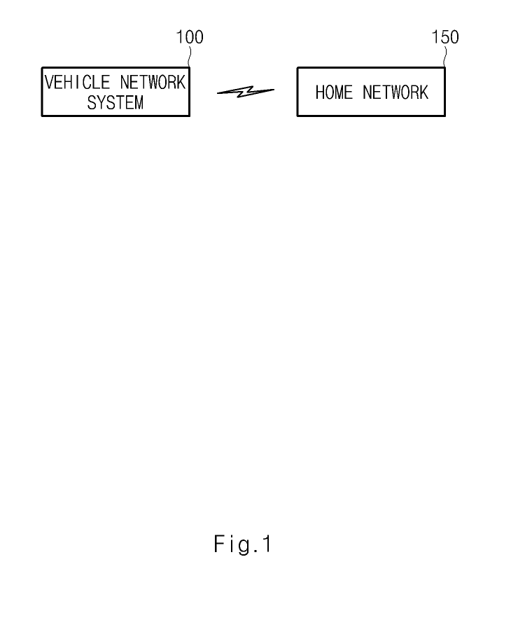

FIG. 1 is a view illustrating a vehicle network system and a home network according to an exemplary embodiment of the present invention.

In the present invention, the vehicle network system 100 is provided within a vehicle and configured to interconnect with a network that is accessible outside of the vehicle via a wireless communication network such as WCDMA, WiBro, or Wi-Fi. To perform communication with an external network, the vehicle network system 100 can use one communication method or two or more different communication methods depending on a range and an environment of wireless communication.

A home network 150 includes a home server provided at home and a residence server that communicates with and controls each home server. The home network 150 can control various communications and provide smart home services in the home and a residence area. The home network 150 can be configured to control electronic devices that use, e.g., RS-485 communication. Also, the home network 150 can be configured to control an in-home system by using, e.g., an RS-232 interface or common control protocol (CCP) or transmission control protocol/internet protocol (TCP/IP).

For example, the home network 150 may perform various functions such as providing an image of the inside of a home or a residential area; monitoring and controlling water, electricity, lighting and room temperature; controlling electronic devices configured to perform communication; inspecting a door, a window and a gas and electricity sensor inside the home; detecting an arrival of a parcel or a guest; and collecting elevator information. The home network 150 interconnects with the vehicle network system 100 via a wireless communication network.

When a predetermined request signal is transmitted from the vehicle network system 100 to the home network 150, the home network 150 is configured to perform an operation corresponding to the request signal within, e.g., about a second from a time point at which the request signal is transmitted.

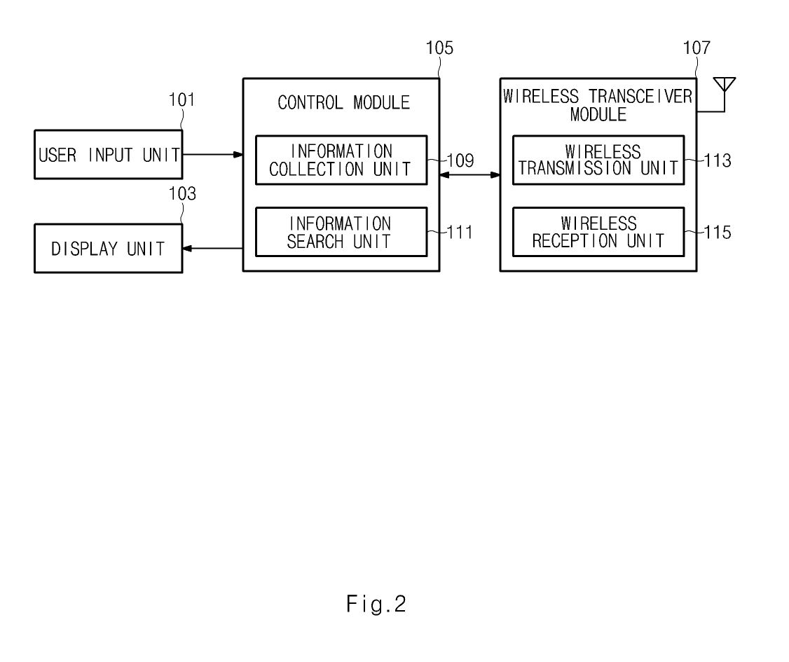

FIG. 2 is a view illustrating a configuration of a vehicle network system according to an exemplary embodiment of the present invention.

As illustrated in FIG. 2, the vehicle network system 100 includes a user input unit 101, a display unit 103, a control module 105 and a wireless transceiver module 107. The vehicle network system 100 according to the present invention may have a different configuration according to other exemplary embodiments. In this illustrative embodiment of the present invention, the control module 105 includes a vehicle information collection unit 109 and an information search unit 111 and the wireless transceiver module 107 includes a wireless transmission unit 113 and a wireless reception unit 115.

The user input unit 101 receives a signal from a user. Predetermined information can be requested from the home network 150 through the user input unit 101 and the information search unit 111 can be controlled through the user input unit 101.

Information that is received from the network 150 or information that is stored in the vehicle network system 100 in some embodiments of the present invention is displayed to the user via the display unit 103.

The control module 105 is connected to respective electronic control devices present within the vehicle to receive and analyze information from the electronic control devices. For example, the control module 105 can determine whether a communication with the home network 150 is operated normally. That is, when a predetermined request signal is transmitted to the home network 150, the control module determines whether a response signal acknowledgement (ACK) has been transmitted from the home network 150. When the response signal ACK is not transmitted, the same request signal is retransmitted a predetermined amount of times, e.g., three times in a consecutive order. If after the additional transmissions the response signal is not received by the control module, the request signal transmissions can be terminated. Furthermore, when an error occurs during the communication with the home network 150, the control module 105 can display a communication a message indicating that the communication is not available or a communication error message on the display unit 103.

The wireless transceiver module 107 in the illustrative embodiment of the present invention is configured to transmit and receive one or more signals to/from the home network 150 via the wireless communication network such as WCDMA, WiBro, or Wi-Fi. The wireless transceiver module 107 in the illustrative embodiment converts and transmits the collected information by using, e.g., hybrid multi-channel communication protocol (HMCP) through the control module 105.

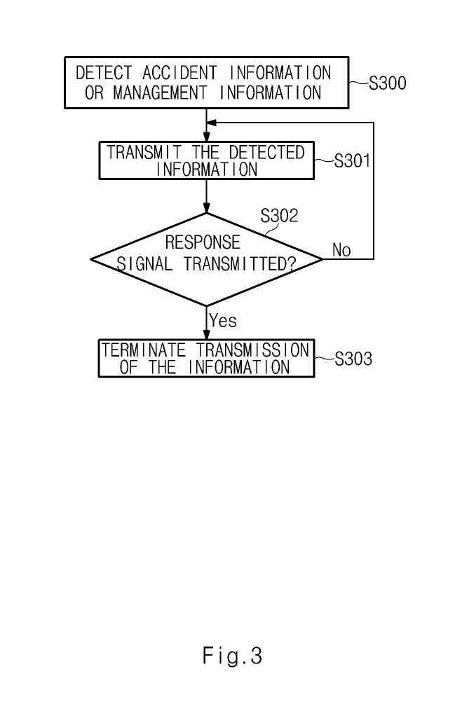

FIG. 3 is a flowchart illustrating a method of operating a vehicle network system according to a first exemplary embodiment of the present invention.

As illustrated in FIG. 3, the vehicle information collection unit 109 detects accident information or management information of the vehicle (S300). For example, vehicle accident information can be detected by an airbag control unit (ACU) message transmitted from an airbag control unit of the vehicle. When a transmission error occurs during transmission of the ACU message, a message indicating the transmission error can be displayed on the display unit 103. Also, when the transmission error of the ACU message occurs, the airbag control unit controlled by the control module 105 can retransmit the same ACU message a predetermined amount of times, e.g., three times, in a consecutive order as described above. The vehicle information collection unit 109 can periodically detect the management information accordingly. In this embodiment of the present invention, the management information includes, for example, information concerning driving or operation status, a consumable, a vehicle, a state of charge (SOC), an all electric range (AER) or whether the vehicle is hybrid electric vehicle (HEV).

The information collected by the vehicle information collection unit 109 is then transmitted to the home network 150 via the wireless transceiver module 107 (S301). The received information can be displayed by the display device incorporated into in the home network 150. The wireless transceiver module 107 can transmit the collected information to the home network 150 within, e.g., a second from a time point at which the accident information or the management information is detected by the vehicle information collection unit 109. The collected information may be transmitted through a wireless network such as WCDMA, WiBro, or Wi-Fi and/or can transmit the collected information periodically to a portable terminal via Bluetooth. Alternatively, the collected information can also be periodically transmitted to the home network 150. For example, when using WCDMA or WiBro network, the collected information can be transmitted every one second.

In addition to notifying the home network 150 that an accident has occurred, the present invention can also provide information relating to the location of the accident to the home network 150. That is, in the event of an accident, the control module 105 can transmit an accident location or a vehicle location based on a global positioning system (GPS) to the home network 150 through the wireless transceiver module 107.

After collected information has been transmitted, the control module 105 determines whether the response signal ACK has been received from the home network 150 (S302). When, according to a determination result at step S302, the response signal ACK is not received, the vehicle information collection unit 109 again transmits the collected information through the wireless transceiver module 107. The control module 105 retransmits the same signal a predetermined amount of times, e.g., three times, in a consecutive order, and when the response signal has not been received in response to the signal being retransmitted the predetermined amount of times consecutively, transmission of the information can be terminated.

However, when it is determined that the response signal ACK has been received at step S302, the wireless transceiver module 107 terminates the transmission of the information collected by the vehicle information collection unit 109 (S303).

It may be advantageous for the user to know when the signal has not been appropriately received by the home network 150. Thus, when the transmission of the collected information or the response signal ACK has failed at each step, the control module 105 can display a message indicating a failure of communication between the vehicle network system 100 and the home network 150 on the display unit 103.

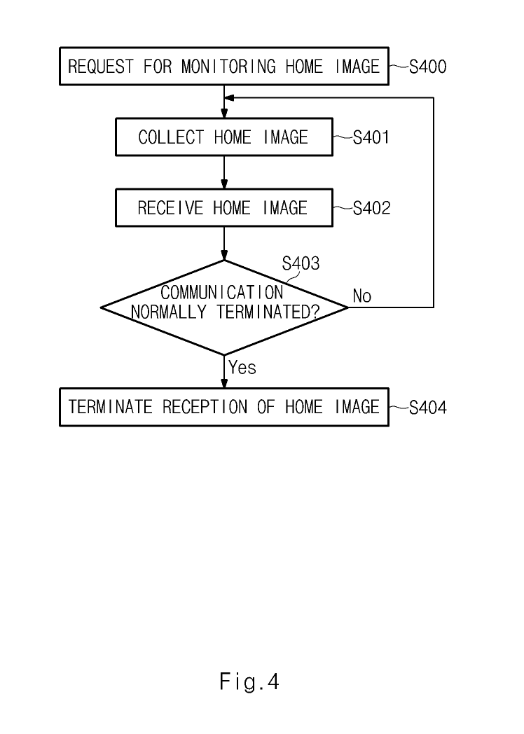

FIG. 4 is a flowchart illustrating a method of operating a vehicle network system according to a second exemplary embodiment of the present invention.

As shown in FIG. 4, a signal for requesting home image monitoring is inputted through the user input unit 101. A home image monitoring request signal is transmitted to the home network 150 through the control module 105 and the wireless transceiver module 107 (S400).

The home network 150 collects the home images according to the received home image monitoring request signal (S401). For example, the home network 150 can operate within about one second after receiving the home image monitoring request signal. In doing so the home network 150 can transmit a collected image to the wireless transceiver module 107 (S402). This collected home image can be transmitted for example as a file or a data stream. The received image can then be displayed on the display unit 103.

Next, the control module 105 determines whether the communication with the home network 150 is normally terminated (S403). Normal termination means that there has been a complete transmission of the collected image. For example, when the image monitoring request signal is transmitted, it is determined whether the response signal ACK with respect to transmitted information has been sent from the home network 150. When it is determined that the response signal ACK has not sent, the same signal is retransmitted a predetermined number of time, e.g., three times, in a consecutive order. In the event that the response signal ACK is not transmitted from the home network 150 in response to the signal being retransmitted three consecutive times, transmission of the image monitoring request signal can be terminated by the vehicle network system. Also, when an error occurs during transmission of the collected image, the control module 105 can display a transmission failure message or a transmission error message on the display unit 103.

In step S403, when the communication is normally terminated, the control module 105 terminates the communication with the home network 150 (S404).

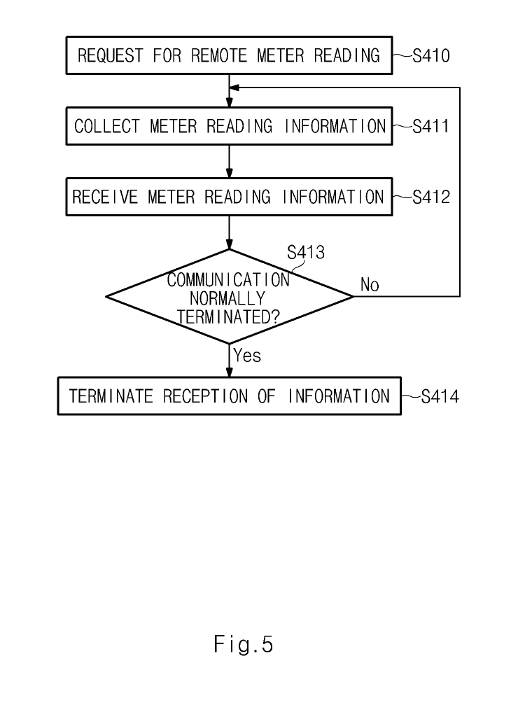

FIG. 5 is a flowchart illustrating a method of operating a vehicle network system according to a third exemplary embodiment of the present invention.

As shown in FIG. 5, a remote meter reading request signal can be inputted through the user input unit 101. The inputted remote meter reading request signal is then transmitted to the home network 150 through the control module 105 and the wireless transceiver module 107 (S410).

The home network 150 collects meter reading information (S411), and transmits the collected meter reading information through the wireless transceiver module 107 of the vehicle network system 100 (S412). For example, the home network 150 can collect and transmit information related to water, gas, electricity, lighting or room temperature inside the home. The received meter reading information can then be displayed on the display unit 103.

Next, the control module 105 determines whether the communication with the home network 150 can be normally terminated (S413). If the communication is normally terminated, the control module then terminates reception of the meter reading information from the home network 150 (S414). When an error occurs during communication with the home network 150, the home network 150 recollects the meter reading information to be transmitted to the wireless transceiver module 107. When the communication error occurs repeatedly, the control module 105 can terminate the communication with the home network 150 according to method similar to those described above.

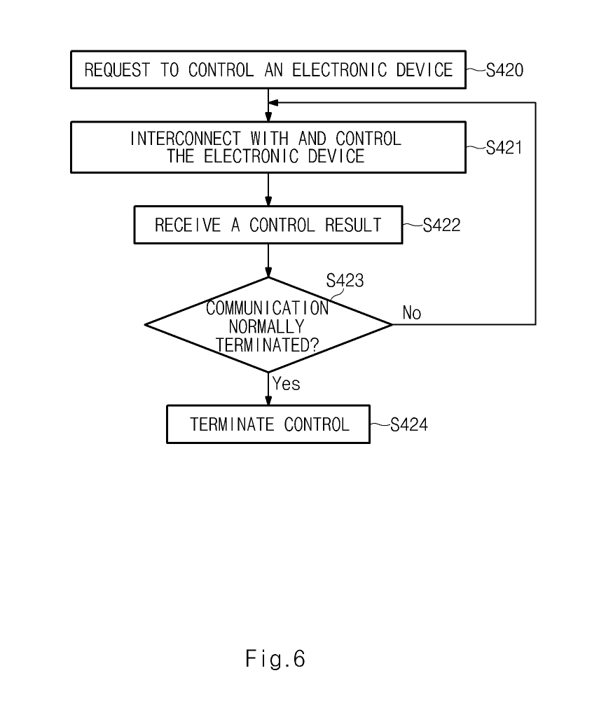

FIG. 6 is a flowchart illustrating a method of operating a vehicle network system according to a fourth exemplary embodiment of the present invention.

As shown in FIG. 6, an electronic device control signal is inputted through the user input unit 101. The electronic device control signal is then transmitted to the home network 150 through the control module 105 and the wireless transceiver module 107 (S420). In response, the home network 150 interconnects with and controls the electronic devices within the home network 150 according to the electronic device control signal (S421).

Next, the home network 150 transmits a result of interconnection and control of the electronic device to the vehicle network system 100 via the wireless transceiver module 107 (S422). The home network 150 can interconnect with and control, for example, a television, a refrigerator, a laundry machine, or an audio device. In doing so, the received control result can then be displayed on the display unit 103.

Next, the control module 105 determines whether the communication with the home network 150 can be normally terminated (S423) and, when the communication is normally terminated, terminates reception of the interconnection and control result from the home network 150 (S424). When the communication error occurs repeatedly, the control module 105 can terminate the communication with the home network 150 accordingly.

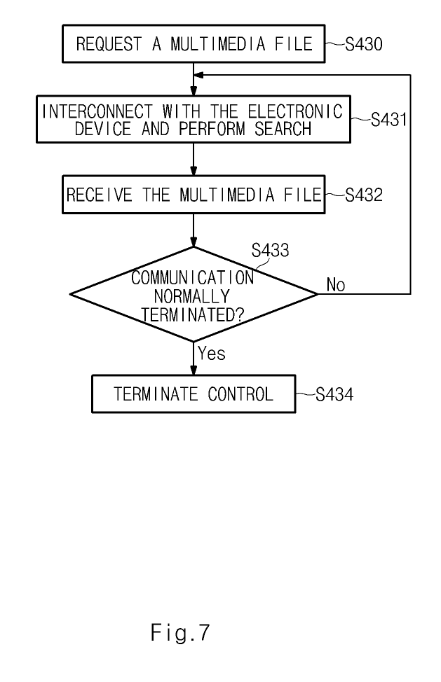

FIG. 7 is a flowchart illustrating a method of operating a vehicle network system according to a fifth exemplary embodiment of the present invention.

As shown in FIG. 7, an exemplary multimedia file request signal is inputted through the user input unit 101. The multimedia file request signal is then transmitted to the home network 150 through the control module 105 and the wireless transceiver module 107 (S430). Here, the information search unit 111 can be used to search the multimedia file in the home network 150. The multimedia file included in the home network 150 is searched by the information search unit 111 so that the home network 150 can be requested for the multimedia file.

The home network 150, in connection with the electronic device within the home, searches for the requested multimedia file according to the transmitted multimedia file request signal (S431). The home network 150 can then search for the requested multimedia file in connection with, for example, the television, the computer, the portable multimedia player within the home.

Next, the home network 150 transmits the searched multimedia file to the vehicle network system 100 through the wireless transceiver module 107 (S432). The home network 150 can then transmit the multimedia file as a single file or data stream and be displayed on the display unit 103.

Next, the control module 150 determines whether the communication with the home network 150 can be normally terminated (S433), and when the communication is normally terminated, terminates reception of the multimedia file from the home network 150 (S434). After the multimedia file is transmitted, the transmitted multimedia file can be searched by the information search unit 105. According to a request from the user input unit 101, a list of multimedia files can be displayed and a selected multimedia file can then be reproduced.

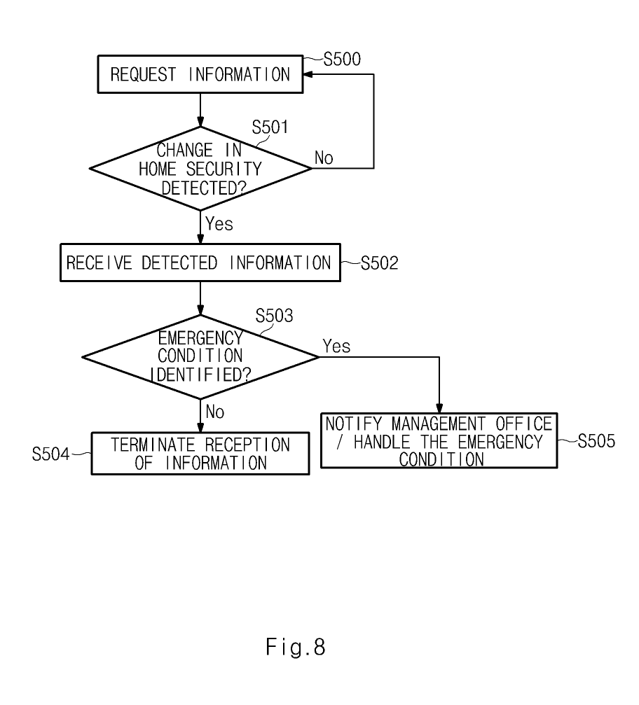

FIG. 8 is a flowchart illustrating a method of operating a vehicle network system according to a sixth exemplary embodiment of the present invention.

As shown in FIG. 8, when an event detectable by the home network 150 is generated, the vehicle network system 100 sends a request to the home network 150 which requests information related to the event and in response the requested information is subsequently sent and received by the vehicle network system as requested. (S500).

Subsequently, the home network 150 determines whether a change in home security has been detected (S501). When the change in the home security is detected, the home network 150 transmits detected information to the vehicle network system 100 through the wireless transceiver module 107 (S502). The received information can be then displayed in the display unit 103. For example, when a change is detected in a door, a window, a gas sensor, or an electricity sensor inside the home in which the home network 150 is provided, the home network 150 can be configured transmit the detected information accordingly.

Next, the control module 105 determines if an emergency condition has occurred (S503). Whether the emergency condition has occurred can be determined depending upon one or more pre-defined conditions. Alternatively, when the information transmitted at step S502 is displayed on the display unit 103, the emergency condition can be identified based on an input signal received through the user input unit 101.

When the emergency condition is not identified, the control module 105 terminates reception of information from the home network 150 (S504). Meanwhile, when the emergency condition is identified, the control unit 105 transmits an, second signal or an abnormality signal to a management office through the wireless transceiver module 107 according to a transmitted signal and receives information related to how to handling the identified situation from the management office (S505). Alternatively, instead of the control unit 105, the home network 150 can transmit the second signal or abnormality signal according to a control signal transmitted from the control unit 105 to the home network 150 and receive the information related to how to handle situation. The information received can then be sent to the vehicle network system 100.

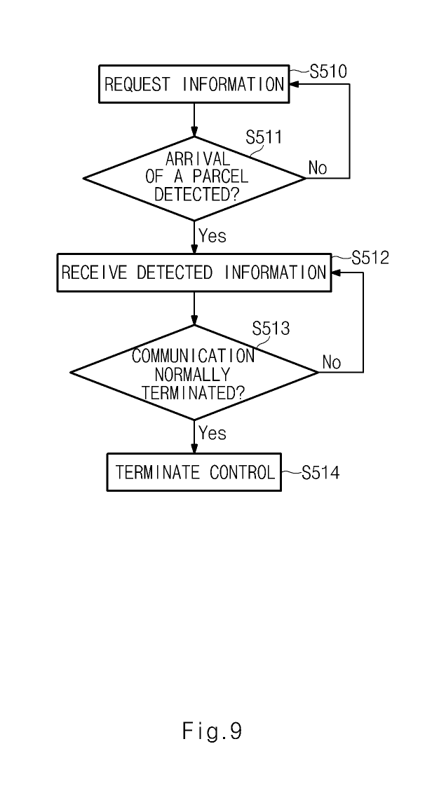

FIG. 9 is a flowchart illustrating a method of operating a vehicle network system according to a seventh exemplary embodiment of the present invention. When the event detectable by the home network 150 is generated, the vehicle network system 100, in this embodiment of the present invention, requests from the home network 150 information related to the event be sent to the vehicle network system 100 (S510).

The home network then determines whether a parcel is received by a courier service at the home (S511). Upon detection of arrival of the parcel, the home network 150 transmits detected information to the vehicle network system 100 through the wireless transceiver module 107 (S512). The received information can then be displayed on the display unit 103.

Next, the control module 105 determines whether the communication with the home network 150 can be normally terminated (S513), and when the communication can be normally terminated, the communication with the home network 150 is terminated accordingly (S514).

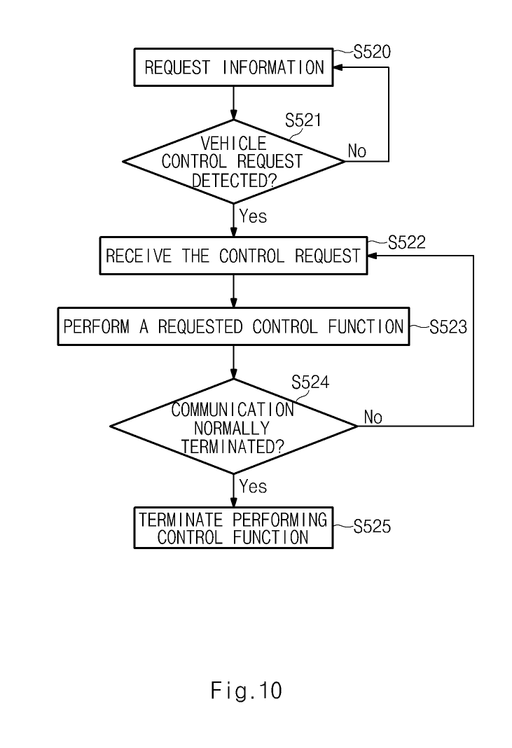

FIG. 10 is a flowchart illustrating a method of operating a vehicle network system according to an eighth exemplary embodiment of the present invention.

As shown in FIG. 10, when the event detectable by the home network 150 is generated, the home network 150 requests information related to the event be sent to the vehicle network system 100 (S520).

The home network 150 determines whether a vehicle control request has been detected (S521). The vehicle control request may include, for example, a vehicle door lock, a trunk lock, and/or an illumination control in the vehicle equipped with the vehicle network system 100. When the vehicle control request is detected, the vehicle control request is transmitted to the vehicle network system 100 through the wireless transceiver module 107 (S522). The received information can then be displayed on the display unit 103. In response, the control unit 105 performs a control function of the vehicle according to the received vehicle control request (S523).

Next, the control module 105 determines whether the communication with the home network 150 can be normally terminated (S523), and when the communication is normally terminated, transmission of the vehicle control request signal from the home network 150 is terminated accordingly (S524).

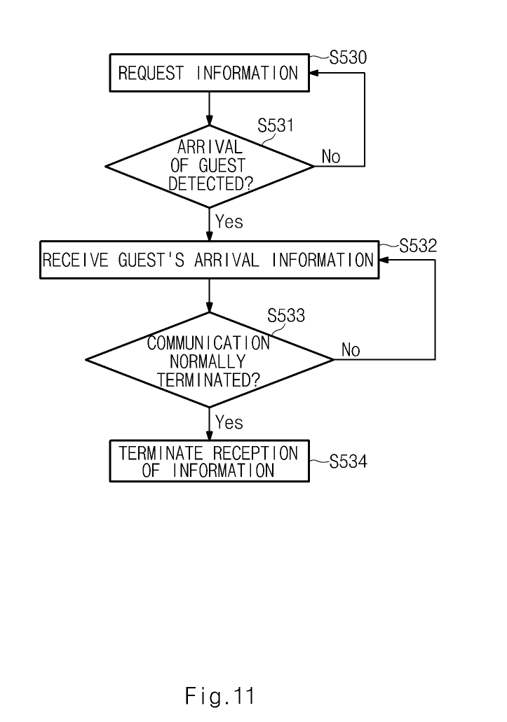

FIG. 11 is a flowchart illustrating a method of operating a vehicle network system according to a ninth exemplary embodiment of the present invention.

As shown in FIG. 11, when the event detectable by the home network 150 has been generated, the vehicle network system 100 sends a request to the home network 150 requesting information related to the event be sent to the vehicle network system 100 (S530).

In this embodiment, the home network 150 determines whether an arrival of a guest is detected (S531). For example, when a guest arrives at a home equipped with the home network 150, the home network 150 transmits information related to the arrival of the guest to the vehicle network system 100 through the wireless transceiver module 107 (S532). The received information can be displayed on the display unit 103. Also, the vehicle network system 100 can further include a phone system to allow the guest to place a phone call so that the guest can conduct a voice or video call with the driver or passengers in the car.

Next, the control module 105 determines whether the communication with the home network 150 can be normally terminated (S533), and when the communication is normally terminated, transmission of the information of the arrival of the guest is terminated (S534).

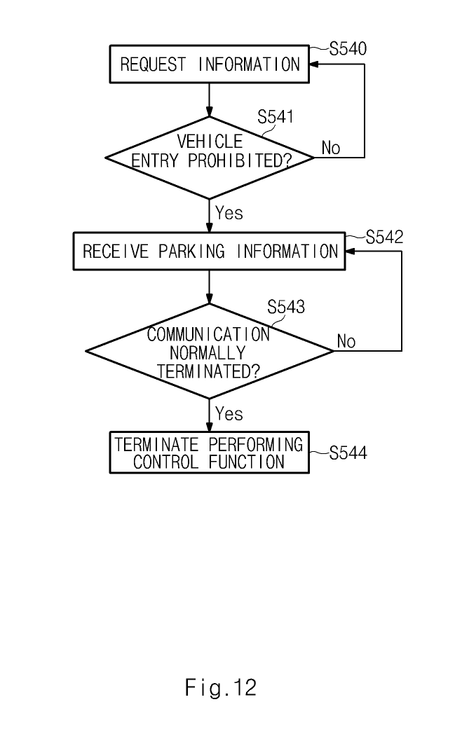

FIG. 12 is a flowchart illustrating a method of operating a vehicle network system according to a tenth exemplary embodiment of the present invention.

As shown in FIG. 12, when the event detectable by the home network 150 is generated, the vehicle network system 100 sends a request to the home network 150 requesting information related to the event be sent to the vehicle network system 100 (S540).

The home network 150 determines whether the vehicle network system is detected within a predetermined range (S541). The home network 150 in this embodiment may include a radio frequency identification (RFID) system to detect the presence of the vehicle network system. The predetermined range can be set as, for example, an area with a radius of 1 km or 5 km. When the vehicle network system is detected within the predetermined range, the home network 150 transmits parking information with respect to the vehicle equipped with the vehicle network (S542). The transmitted parking information can then be displayed on the display unit 103.

Next, the control module 105 determines whether the communication with the home network 150 can be normally terminated (S543), and when the communication is normally terminated, transmission of the parking information from the home network 150 is terminated accordingly (S544).

The present invention may be embodied as a computer readable code on a computer readable recording medium executed by a processor. The computer readable recording medium includes any type of recording medium that can store a data readable by the processor. Examples of the computer readable recording medium include ROM, RAM, compact disc (CD)-ROMs, magnetic tapes, floppy disks, and optical data storage devices. The computer readable recording medium can also be distributed in a network coupled to one or more computer systems so that the computer readable code is stored and executed in a distributed fashion.

Advantageously, the present invention allows for various functions provided in the home network to be controlled from within the vehicle. Thus, various devices and systems connected to the home network can be remotely controlled from within the vehicle in which the vehicle network is installed. Therefore, home security can be easily implemented and the electronic devices within the home can be controlled from the vehicle. Inversely the vehicle can also be periodically controlled from within home network as well.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A vehicle network system interconnected with a home network, the vehicle network system comprising:
a vehicle information collection unit configured to detect accident information or management information of a vehicle; and
a wireless transceiver unit configured to transmit information detected by the vehicle information collection unit to the home network via a wireless communication network and configured to receive a response signal from the home network.

2. The vehicle network system according to claim 1, wherein the wireless communication network is at least one of a group consisting of a WCDMA network, a WiBro network, and a WiFi network.

3. The vehicle network system according to claim 1, wherein the home network is configured to display the information transmitted through the wireless transceiver unit.

4. The vehicle network system according to claim 1, wherein the vehicle information collection unit is configured to periodically detect the accident information or the management information of the vehicle.

5. The vehicle network system according to claim 1, wherein the wireless transceiver unit is configured to convert the detected information by using a hybrid multi-channel communication protocol (HMCP) for transmission.

6. A vehicle network system interconnected with a home network, the vehicle network system comprising:
a user input unit configured to receive, from a user, a request for a control function operable in the home network;
a wireless transmission unit configured to request the control function requested through the user input unit to the home network via a wireless communication network;
a wireless reception unit configured to receive a result of the control function operated by the home network via the wireless communication network; and
a display unit configured to display the result transmitted through the wireless reception unit.

7. The vehicle network system according to claim 6, wherein the wireless communication network is at least one of a group consisting of a WCDMA network, a WiBro network, and a WiFi network.

8. The vehicle network system according to claim 6, wherein the control function is a command to monitor an image of a residential area or an inside of a home in real time.

9. The vehicle network system according to claim 6, wherein the control function is a command to monitor at least one of a group consisting of water, gas, electricity, lighting, and room temperature within a home in which the home network is provided.

10. The vehicle network system according to claim 6, wherein the control function is a command to control an electronic device that is interconnected with the home network.

11. The vehicle network system according to claim 10, wherein, when the electronic device includes a multimedia file, and the wireless reception unit is configured to receive the multimedia file.

12. The vehicle network system according to claim 11, wherein the display unit displays a list of the multimedia files, and a selected multimedia file is reproduced according to a request inputted to the user input unit.

13. A vehicle network system interconnected with a home network, the vehicle network system comprising:
a wireless reception unit configured to receive information transmitted from the home network via a wireless communication network upon an occurrence of the event detectable by the home network; and
a display unit configured to display a result transmitted through the wireless reception unit.

14. The vehicle network system according to claim 13, wherein the wireless communication network is at least one of a group consisting of a WCDMA network, a WiBro network, and a WiFi network.

15. The vehicle network system according to claim 13, wherein the event is at least one of a group consisting of a change being detected in a door, a window, a gas, and an electricity sensor inside a home in which the home network is provided.

16. The vehicle network system according to claim 13, wherein the event is an arrival of a parcel at a home in which the home network is provided.

17. The vehicle network system according to claim 13, wherein the event is a request generated for at least one of a group consisting of a vehicle door lock, a trunk lock, or an illumination control in a vehicle in which the vehicle network system is provided.

18. The vehicle network system according to claim 13, wherein the event is an arrival of a guest at a home in which the home network is provided.

19. The vehicle network system according to claim 18, further comprising:
a phone system configured to allow the guest to place a phone call to the vehicle network system.

20. The vehicle network system according to claim 13, wherein the event is a detection of a vehicle network system by the home network within a predetermined range and, upon the event occurring, parking information being sent to a vehicle in which the vehicle network system is provided.
